(19) United States
(12) Patent Application Publication
(10) Pub. No.: US 2024/0157336 A1
(43) Pub. Date: May 16, 2024

(54) SYSTEMS AND METHODS FOR IN-SITU COKE REMOVAL FROM HOT-GAS PATH SURFACES

(71) Applicant: General Electric Company, Schenectady, NY (US)

(72) Inventors: Karthick Gourishankar, Bengaluru (IN); Lawrence B. Kool, Clifton Park, NY (US); Byron A. Pritchard, Loveland, OH (US); Sanjay Kumar Sondhi, Bengaluru (IN); Narayanan Janakiraman, Bengaluru (IN); Arundhati Sengupta, Bengaluru (IN); Atanu Saha, Bengaluru (IN); Bernard P. Bewlay, Niskayuna, NY (US)

(21) Appl. No.: 18/319,714

(22) Filed: May 18, 2023

(30) Foreign Application Priority Data
Nov. 16, 2022 (IN) 202211065708

(51) Int. Cl. B01J 23/10; B01J 23/42; B01J 23/50; B01J 35/02; F02C 7/30

(52) U.S. Cl. CPC B01J 23/10; B01J 23/42; B01J 23/50; B01J 35/023; F02C 7/30

(57) ABSTRACT

A mixer assembly for a gas turbine engine. The mixer assembly includes a housing and a fuel injection port. The housing has a passage formed therein, and the housing includes a passage wall facing the passage. The fuel injection port is fluidly connected to a fuel source and is configured to inject a hydrocarbon fuel into the passage. At least a portion of the passage wall is a coated passage wall. The coated passage wall is (i) coated with a layer of catalyst particles comprising a rare earth oxide component and (ii) located downstream of the fuel injection port.

### CROSS REFERENCE TO RELATED APPLICATIONS

The present application claims the benefit of Indian Patent Application No. 202211065708, filed on Nov. 16, 2022, which is hereby incorporated by reference herein in its entirety.

### TECHNICAL FIELD

The present disclosure relates to mixer assemblies, particularly, mixer assemblies used in gas turbine engines.

### BACKGROUND

Gas turbine engines include surfaces that contact hydrocarbon fluids, such as fuels and lubricating oils. Carbonaceous deposits (also known as coke) may form on these surfaces when exposed to the hydrocarbon fluids at elevated temperatures, resulting in carbon becoming attached to surfaces contacted by a fuel or oil and building up as deposits on those surfaces contacted by a fuel or oil.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic, cross-sectional view, of catalyst particle coatings applied on surfaces of a venturi and an aft heat shield.

FIG. 2 is a schematic perspective view of an aircraft having a gas turbine engine according to an embodiment of the present disclosure.

FIG. 3 is a schematic, cross-sectional view, taken along line 2-2 in FIG. 2, of the gas turbine engine of the aircraft shown in FIG. 2.

FIG. 4 is a schematic, cross-sectional view of a combustor of the gas turbine engine shown in FIG. 3 according to an embodiment of the present disclosure. FIG. 4 is a detail view showing detail 3 in FIG. 3.

FIG. 5 is a schematic, cross-sectional view of a mixer assembly of the combustor in FIG. 4. FIG. 5 is a detail view showing detail 4 in FIG. 4.

FIG. 6 is a schematic, cross-sectional view of a combustor of the gas turbine engine shown in FIG. 3 according to another embodiment of the present disclosure.

FIG. 7 is a schematic, cross-sectional view of a mixer assembly of the combustor in FIG. 6. FIG. 7 is a detail view showing detail 6 in FIG. 6.

FIG. 8 is a cross-sectional scanning electron microscope (SEM) image of CeO₂ coated onto an INCONEL® 625 substrate.

FIG. 9 is a graphical representation showing efficacy of coke combustion using a rare earth oxide-based catalyst.

FIG. 10 is a graphical representation showing onsets and peaks of carbon oxidation reactions in samples of carbon-based pellets including a rare earth oxide-based catalyst as a function of temperature.

FIG. 11 is a graphical representation showing consumption of carbon mass of carbon-based pellets including a rare earth oxide-based catalyst as a function of temperature.

### DETAILED DESCRIPTION

Features, advantages, and embodiments of the present disclosure are set forth or apparent from a consideration of the following detailed description, drawings, and claims. Moreover, it is to be understood that the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the spirit and the scope of the present disclosure.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows. The term “fluid” may be a gas or a liquid. The term “fluid communication” means that a fluid is capable of making the connection between the areas specified.

The terms “directly upstream” or “directly downstream,” when used to describe the relative placement of components in a fluid pathway, refer to components that are placed next to each other in the fluid pathway without any intervening components between them other than an appropriate fluid coupling, such as a pipe, tube, valve, or the like, to fluidly couple the components. Such components may be spaced apart from each other with intervening components that are not in the fluid pathway.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The term “rare earth” refers to elements of groups 3 and 4 of the first, second, and third transition series of the periodic table, e.g., scandium, yttrium, zirconium, and hafnium, and elements of the lanthanide series of the periodic table, e.g., lanthanum, cerium, praseodymium, neodymium, promethium, samarium, europium, gadolinium, terbium, dysprosium, holmium, erbium, thulium, ytterbium, and lutetium.

The term “noble metal” refers to elements of groups 7 to 11 of the second and third transition series of the periodic table, e.g., rhenium, ruthenium, rhodium, palladium, silver, osmium, iridium, platinum, and gold.

The term “δ” refers to oxygen vacancies that form within a metal-doped cerium-based oxide to balance the charge in the respective metal-doped cerium-based oxide.

The abbreviation “a.u.” refers to arbitrary units.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” is not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values, and/or endpoints defining range(s) of values.

Here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other.

As noted above, coke deposition may occur on surfaces of a gas turbine engine that are exposed to hydrocarbon fluids, such as fuels and lubricating oils, at elevated temperatures. The fuel nozzle and swirler (collectively, a mixer assembly) used in a combustor for a gas turbine engine includes such surfaces. The fuel nozzle aft heat shield (FN-AHS) protects the fuel nozzle from hot combustion gases during engine operation. Surfaces of the FN-AHS and other surfaces of the mixer assembly are exposed to hydrocarbon fluids, such as fuel, and operation of the gas turbine engine, particularly, continuous operation at cruise for aircraft gas turbine engines, can result in significant build-up of coke and/or partially burned fuel deposits on exposed surfaces of the FN-AHS and the mixer assembly.

Coke can build up in considerable thickness, and large pieces of coke can shed off these surfaces, becoming internal domestic objects that can cause significant damage to components downstream of the fuel nozzle (hot gas path components). Some of these components have thermal barrier coatings (TBCs). The resulting internal domestic object impact damage (DoD) results in spallation of the thermal barrier coating and, therefore, reduces the durability of components such as combustors, nozzles, shrouds, and airfoils.

The embodiments discussed herein apply a coating of catalyst particles including a rare earth oxide component to these surfaces of the mixer assembly and the fuel nozzle. Suitable rare earth oxides include cerium oxide (including CeO₂), yttrium oxide (including Y₂O₃), praseodymium oxide (Pr₂O₃), lanthanum oxide (including La₂O₃), neodymium oxide (including Nd₂O₃), samarium oxide (including Sm₂O₃), gadolinium oxide (including Gd₂O₃), and terbium oxide (including Tb₄O₇). In some embodiments, a cerium oxide (including CeO₂) or any cerium-based oxide may be the preferred rare earth oxide component.

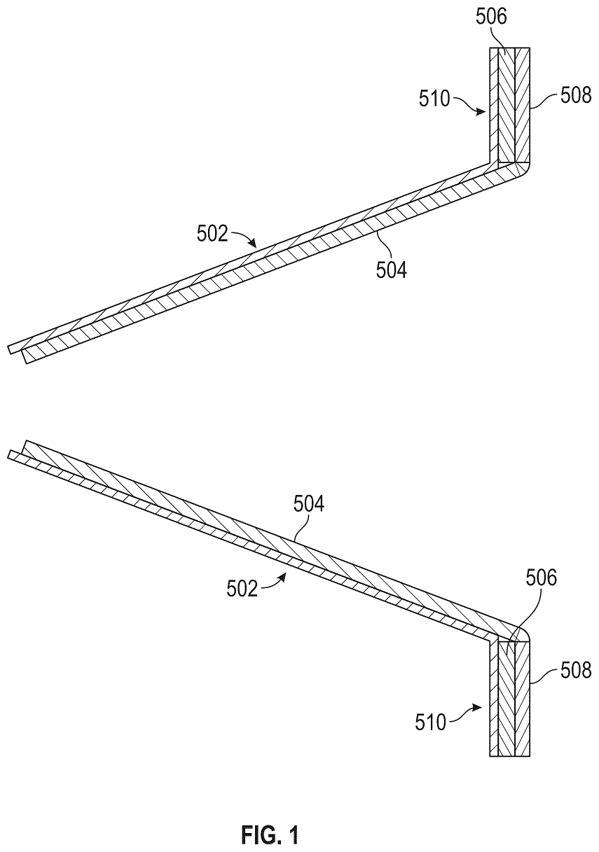

As shown for example in FIG. 1, a catalyst particle layer 504 can exist on a surface of a venturi wall 502. Also, a catalyst particle layer 508 can exist on the surface of the TBC 506, which exists on the surface of the AHS 510.

In some embodiments, the rare earth oxide component further includes zirconium, hafnium, praseodymium, neodymium, promethium, samarium, europium, gadolinium, terbium, dysprosium, holmium, erbium, thulium, ytterbium, or lutetium. The cerium-based oxide may have an overall formula of Ce₁₋ₓ(RE)ₓO₂₋₆, where RE represents the above metals other than cerium, x ranges from 0.1 to 0.5, and δ ranges from 0 to 0.1 (preferably 0 to 0.05). Alternatively, the cerium-based oxide may have an overall formula of Ce_{1-(x+y)}(RE1)ₓ(RE2)_{y}O₂₋₆, where RE1 and RE2 represent two of the above metals other than cerium, x+y ranges from 0.1 to 0.5, and δ ranges from 0 to 0.1 (preferably 0 to 0.05).

In some embodiments, the cerium-based oxide further includes an alkali metal or an alkaline earth metal. Without intending to be bound to any theory, the alkali metal or alkaline earth metal component improves contact with coke due to improved mobility of these metals. Alkali metals and alkaline earth metals have NOₓ⁻ storage ability and can improve coke oxidation in an environment with NOₓ⁻ availability. The cerium-based oxide may have an overall formula of Ce₁₋ₓ(M)ₓO₂₋₆, where M represents an alkali metal or an alkaline earth metal, x ranges from 0.05 to 0.5, and δ ranges from 0 to 0.1 (preferably 0 to 0.05). Alternatively, the cerium-based oxide may have an overall formula of Ce_{1-(x+y)}(M1)ₓ(M2)_{y}O₂₋₆, where M1 and M2 represent two different alkali metals or alkaline earth metals, x+y ranges from 0.05 to 0.5, and 6 ranges from 0 to 0.1 (preferably 0 to 0.05).

In some embodiments, the catalyst particle further includes a noble metal component forming a rare earth oxide-noble metal composite, for example, a cerium oxide-noble metal composite. In some embodiments, the catalyst particle further includes a silver component forming a rare earth oxide-silver composite, for example, a cerium oxide-silver composite. The content of the silver component may range from one weight percent to fifty weight percent of the catalyst particle, two weight percent to forty weight percent of the catalyst particle, three weight percent to thirty weight percent of the catalyst particle, four weight percent to twenty-five weight percent of the catalyst particle, or five weight percent to twenty weight percent of the catalyst particle.

In some embodiments, the catalyst particle further includes a platinum component, forming a rare earth oxide-platinum composite, for example, a cerium oxide-platinum composite. The content of the platinum component may range from twenty-five weight percent to ninety-five weight percent of the total noble metal component, thirty weight percent to ninety weight percent of the total noble metal component, or forty weight percent to eighty weight percent of the total noble metal component.

In some embodiments, the catalyst particle includes the rare earth oxide component, the silver component, and the platinum component forming a rare earth oxide-silver-platinum composite, for example, a cerium oxide-silver-platinum composite.

Without intending to be bound to any theory, the rare earth oxide component of the catalyst particle provides oxygen ions (Oₙ^{x-}) for coke oxidation via oxygen transport. Oxygen migrates to the rare earth oxide surface to form Oₙ^{x-} species that are transported to coke particles at the rare earth oxide-coke interface, thereby, oxidizing the coke. Without intending to be bound to any theory, the noble metal component of the catalyst particle, owing to its gaseous oxygen adsorption capacity, collects gaseous oxygen and also oxygen from the rare earth oxide and aids a fast transfer of oxygen to coke particles, acting as a channel. Also, the noble metal component aids electron transport in a redox process, for example, from converting Ce⁴⁺ to Ce³⁺ and vice versa. Platinum provides modification of coke morphology rendering a particulate, dispersed form than a glassy, non-dispersible form. In environments with NOₓ⁻ availability, platinum can aid NOₓ⁻-assisted coke oxidation. Silver provides improved coke oxidation in the absence of NOₓ⁻.

In some embodiments, the catalyst particle further includes manganese oxide, zirconium oxide, titanium oxide, copper oxide, bismuth oxide, tin oxide, or thallium oxide.

In some embodiments, the catalyst particle is based on tin oxide, manganese oxide, or the like, or a composite thereof, and additionally includes a noble metal component such as silver resulting in SnO₂—Ag, MnO₂—Ag, or the like, respectively.

In some embodiments, the AHS of the mixer assemblies can contain a TBC that is exposed to the hydrocarbon and combustion atmosphere. Example materials of TBCs include yttria-stabilized zirconia (YSZ such as 8 YSZ, 20 YSZ, 55 YSZ), La—Gd-Zirconate, La—Yb-Zirconate, La—Gd—Yb-Zirconate, rare-earth-Ta-Zirconate, rare-earth-Nb-Zirconate.

In some embodiments, the catalyst particles can be integrated into TBC materials as a thin coating via sol-gel precursor or sol impregnation, to allow the coating to adhere conformally without altering the TBC roughness or adversely affecting useful features such as dense vertical cracks (DVC), which assist strain compliance. In some embodiments, the catalyst particles can be integrated into TBC materials by mixing the source TBC materials in powder form in different proportions (for example, from ten weight percent to ninety-five weight percent) so that they can be applied as part of the TBC application process using APS or EBPVD methods. In some embodiments, the catalyst particles can be integrated into TBC materials as graded layers of catalyst applied on the TBC surface. For example, a first layer is the TBC material, a second layer is a combination of ninety percent TBC material and ten percent catalyst, a third payer is a combination of fifty percent TBC material and fifty percent catalyst, and a fourth layer is one hundred percent catalyst. Up to five layers may exist, each layer having thicknesses ranging from one hundred nanometers to ten microns.

Without the rare earth oxide-based catalyst coating, the coke bonds more strongly to the metallic or ceramic surfaces of the mixer assembly and the fuel nozzle, leading to the formation of larger coke particles that can shed or spall off during operation, as discussed above. As will be discussed further below, the rare earth oxide-based catalyst prevents such build-up and spallation. Without intending to be bound to any theory, certain components of the rare earth oxide-based catalyst coating, including platinum, promotes the formation of filamentary coke, rather than large granular coke. The filamentary coke does not bond to the rare earth oxide-based catalyst surface of the mixer assembly and the fuel nozzle, and the filamentary coke can be easily removed during operation of the mixer assembly and the fuel nozzle in the combustor.

Without intending to be bound to any theory, certain components of the rare earth oxide-based catalyst coating, including platinum, act synergistically with the rest of the catalyst material to aid effective removal of coke from the mixer assembly surfaces. For example, platinum promotes the formation of filamentary or particulate coke, rather than large granular coke. Such a morphology leads to greater surface area and increased contact between coke and the rare-earth oxide-based catalyst for increased effective oxidation of coke, resulting in, overall, a more effective and faster rate of oxidation.

In some embodiments, a combination of perovskite and fluorite may be used in lieu of the rare earth oxide-based catalyst forming the catalytic particle. Perovskite is a mixed conductor and fluorite has a structure with oxygen vacancies. The combination of perovskite and fluorite is capable of catalyzing a coke oxidation reaction.

The rare earth oxide-based catalyst allows reduction of coke burn-off onset temperatures ranging from, preferably, fifty degrees Celsius to five hundred degrees Celsius, and, more preferably, three hundred fifty degrees Celsius to four hundred fifty degrees Celsius.

Coke oxidation using the rare earth oxide-based catalyst can be operated in a temperature ranging from, preferably, one hundred fifty degrees Celsius to one thousand four hundred degrees Celsius, more preferably, one hundred fifty degrees Celsius to six hundred degrees Celsius, more preferably, three hundred degrees Celsius to six hundred degrees Celsius, and, more preferably, six hundred degrees Celsius to one thousand four hundred degrees Celsius.

Coke oxidation using the rare earth oxide-based catalyst can be operated in an oxygen-containing environment ranging from, preferably, five volume percent to twenty-one volume percent of gaseous oxygen, and, more preferably, five volume percent to ten volume percent of gaseous oxygen.

One skilled in the art would recognize that depending on the location where the coke forms, different morphologies may exist due to different temperatures, different oxygen concentrations, different mass flow rates, etc. Also, coke formed in different areas of the fuel nozzle can have different morphologies depending on the fuel nozzle design.

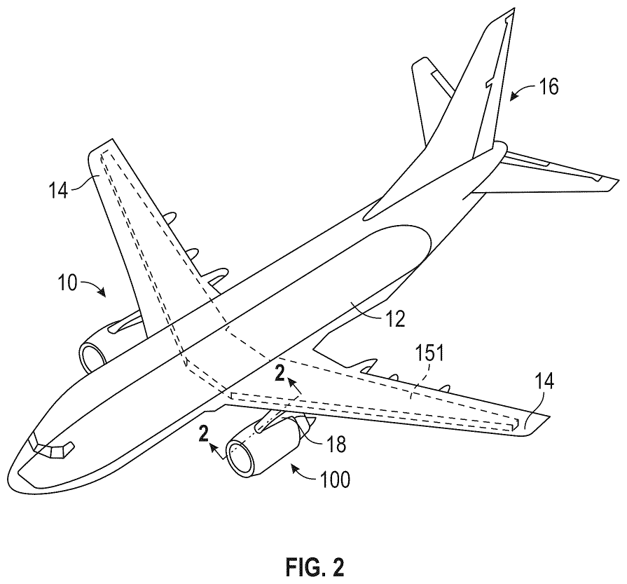

The mixer assembly discussed herein is particularly suitable for use in engines, such as a gas turbine engine used on an aircraft. FIG. 2 is a perspective view of an aircraft 10 that may implement various preferred embodiments. The aircraft 10 includes a fuselage 12, wings 14 attached to the fuselage 12, and an empennage 16. The aircraft 10 also includes a propulsion system that produces a propulsive thrust required to propel the aircraft 10 in flight, during taxiing operations, and the like. The propulsion system for the aircraft 10 shown in FIG. 2 includes a pair of engines 100. In this embodiment, each engine 100 is attached to one of the wings 14 by a pylon 18 in an under-wing configuration. Although the engines 100 are shown attached to the wing 14 in an under-wing configuration in FIG. 2, in other embodiments, the engine 100 may have alternative configurations and be coupled to other portions of the aircraft 10. For example, the engine 100 may additionally or alternatively include one or more aspects coupled to other parts of the aircraft 10, such as, for example, the empennage 16, and the fuselage 12.

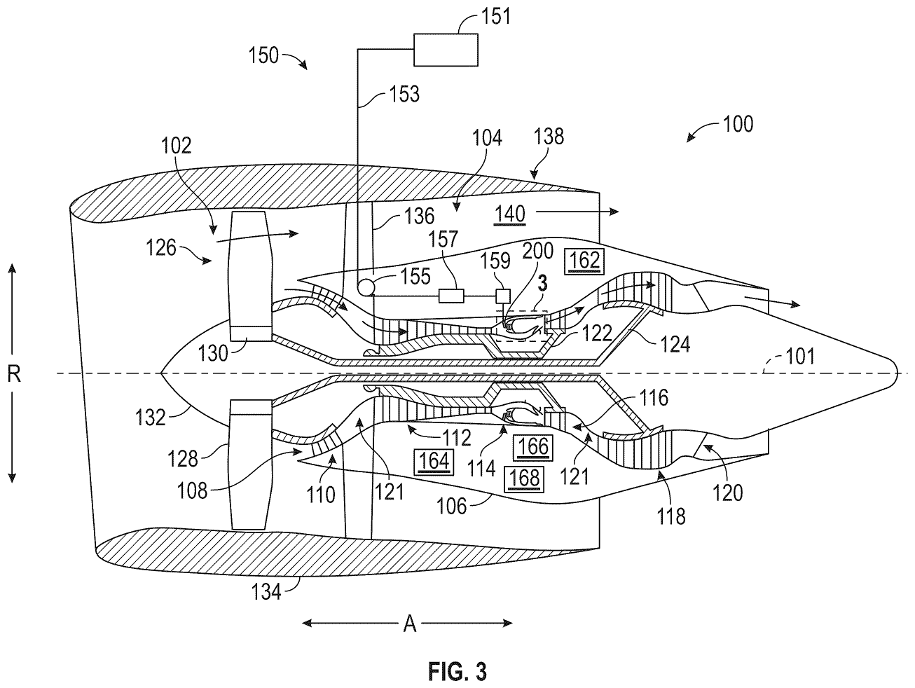

As will be described further below with reference to FIG. 3, the engines 100 shown in FIG. 2 are gas turbine engines that are each capable of selectively generating a propulsive thrust for the aircraft 10. The amount of propulsive thrust may be controlled at least in part based on a volume of fuel provided to the gas turbine engines 100 via a fuel system 150 (see FIG. 3). An aviation turbine fuel in the embodiments discussed herein is a combustible hydrocarbon liquid fuel, such as a kerosene-type fuel, having a desired carbon number. The fuel is stored in a fuel tank 151 of the fuel system 150. As shown in FIG. 2, at least a portion of the fuel tank 151 is located in each wing 14 and a portion of the fuel tank 151 is located in the fuselage 12 between the wings 14. The fuel tank 151, however, may be located at other suitable locations in the fuselage 12 or the wing 14. The fuel tank 151 may also be located entirely within the fuselage 12 or the wing 14. The fuel tank 151 may also be separate tanks instead of a single, unitary body, such as, for example, two tanks each located within a corresponding wing 14.

Although the aircraft 10 shown in FIG. 2 is an airplane, the embodiments described herein may also be applicable to other aircraft 10, including, for example, helicopters and unmanned aerial vehicles (UAV). The aircraft discussed herein are fixed-wing aircraft or rotor aircraft that generate lift by aerodynamic forces acting on, for example, a fixed wing (e.g., wing 14) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 3 is a schematic, cross-sectional view of one of the engines 100 used in the propulsion system for the aircraft 10 shown in FIG. 2. The cross-sectional view of FIG. 3 is taken along line 2-2 in FIG. 2. For the embodiment depicted in FIG. 3, the engine 100 is a high bypass turbofan engine. The engine 100 may also be referred to as a turbofan engine 100 herein. The turbofan engine 100 has an axial direction A (extending parallel to a longitudinal centerline 101, shown for reference in FIG. 3), a radial direction R, and a circumferential direction. The circumferential direction (not depicted in FIG. 3) extends in a direction rotating about the axial direction A. The turbofan engine 100 includes a fan section 102 and a turbomachine 104 disposed downstream from the fan section 102.

The turbomachine 104 depicted in FIG. 3 includes a tubular outer casing 106 (also referred to as a housing or a nacelle) that defines an inlet 108. In this embodiment, the inlet 108 is annular. The outer casing 106 encases an engine core that includes, in a serial flow relationship, a compressor section including a booster or a low-pressure (LP) compressor 110 and a high-pressure (HP) compressor 112, a combustion section 114, a turbine section including a high-pressure (HP) turbine 116 and a low-pressure (LP) turbine 118, and a jet exhaust nozzle section 120. The compressor section, the combustion section 114, and the turbine section together define at least in part a core air flowpath 121 extending from the inlet 108 to the jet exhaust nozzle section 120. The turbofan engine further includes one or more drive shafts. More specifically, the turbofan engine includes a high-pressure (HP) shaft or spool 122 drivingly connecting the HP turbine 116 to the HP compressor 112, and a low-pressure (LP) shaft or spool 124 drivingly connecting the LP turbine 118 to the LP compressor 110.

The fan section 102 shown in FIG. 3 includes a fan 126 having a plurality of fan blades 128 coupled to a disk 130. The plurality of fan blades 128 and the disk 130 are rotatable, together, about the longitudinal centerline (axis) 101 by the LP shaft 124. The LP compressor 110 may also be directly driven by the LP shaft 124, as depicted in FIG. 3. The disk 130 is covered by a rotatable front hub 132 aerodynamically contoured to promote an airflow through the plurality of fan blades 128. Further, an annular fan casing or an outer nacelle 134 is provided, circumferentially surrounding the fan 126 and/or at least a portion of the turbomachine 104. The nacelle 134 is supported relative to the turbomachine 104 by a plurality of circumferentially spaced outlet guide vanes 136. A downstream section 138 of the nacelle 134 extends over an outer portion of the turbomachine 104 so as to define a bypass airflow passage 140 therebetween.

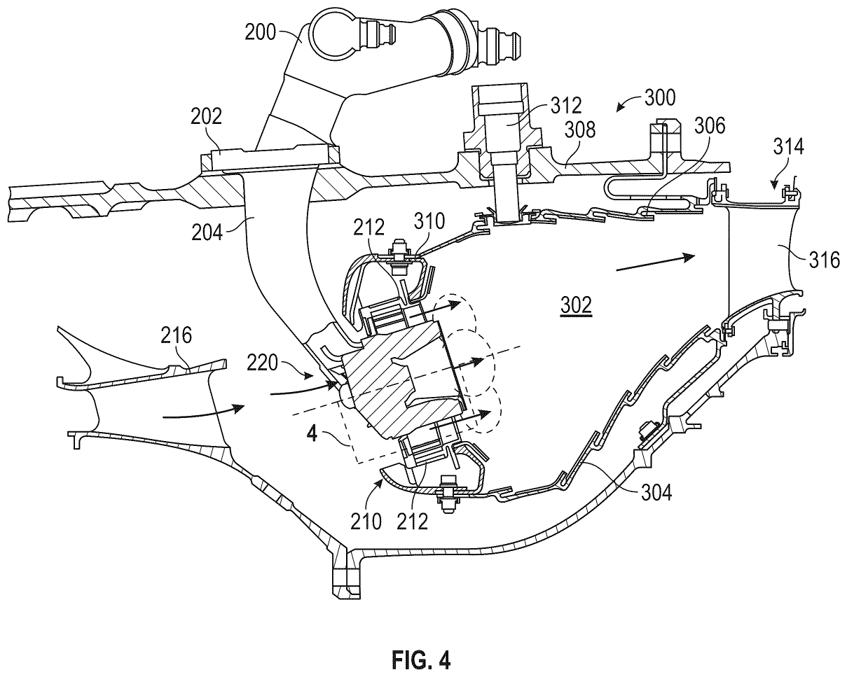

The turbofan engine 100 is operable with the fuel system 150 and receives a flow of fuel from the fuel system 150. The fuel system 150 includes a fuel delivery assembly 153 providing the fuel flow from the fuel tank 151 to the turbofan engine 100, and, more specifically, to a plurality of fuel injectors 200 that inject fuel into a combustion chamber 302 of a combustor 300 (see FIG. 4, discussed further below) of the combustion section 114.

The components of the fuel system 150, and, more specifically, the fuel tank 151, is an example of a fuel source that provides fuel to the fuel injectors 200, as discussed in more detail below. The fuel delivery assembly 153 includes tubes, pipes, conduits, and the like, to fluidly connect the various components of the fuel system 150 to the engine 100. The fuel tank 151 is configured to store the hydrocarbon fuel, and the hydrocarbon fuel is supplied from the fuel tank 151 to the fuel delivery assembly 153. The fuel delivery assembly 153 is configured to carry the hydrocarbon fuel between the fuel tank 151 and the engine 100 and, thus, provides a flow path (fluid pathway) of the hydrocarbon fuel from the fuel tank 151 to the engine 100.

The fuel system 150 includes at least one fuel pump fluidly connected to the fuel delivery assembly 153 to induce the flow of the fuel through the fuel delivery assembly 153 to the engine 100. One such pump is a main fuel pump 155. The main fuel pump 155 is a high-pressure pump that is the primary source of pressure rise in the fuel delivery assembly 153 between the fuel tank 151 and the engine 100. The main fuel pump 155 may be configured to increase a pressure in the fuel delivery assembly 153 to a pressure greater than a pressure within a combustion chamber 302 of the combustor 300.

The fuel system 150 also includes a fuel metering unit 157 in fluid communication with the fuel delivery assembly 153. Any suitable fuel metering unit 157 may be used including, for example, a metering valve. The fuel metering unit 157 is positioned downstream of the main fuel pump 155 and upstream of a fuel manifold 159 configured to distribute fuel to the fuel injectors 200. The fuel system 150 is configured to provide the fuel to the fuel metering unit 157, and the fuel metering unit 157 is configured to receive fuel from the fuel tank 151. The fuel metering unit 157 is further configured to provide a flow of fuel to the engine 100 in a desired manner. More specifically, the fuel metering unit 157 is configured to meter the fuel and to provide a desired volume of fuel, at, for example, a desired flow rate, to the fuel manifold 159 of the engine 100. The fuel manifold 159 is fluidly connected to the fuel injectors 200 and distributes (provides) the fuel received to the plurality of fuel injectors 200, where the fuel is injected into the combustion chamber 302 and combusted. Adjusting the fuel metering unit 157 changes the volume of fuel provided to the combustion chamber 302 and, thus, changes the amount of propulsive thrust produced by the engine 100 to propel the aircraft 10.

The turbofan engine 100 also includes various accessory systems to aid in the operation of the turbofan engine 100 and/or an aircraft, including the turbofan engine 100. For example, the turbofan engine 100 may include a main lubrication system 162, a compressor cooling air (CCA) system 164, an active thermal clearance control (ATCC) system 166, and a generator lubrication system 168, each of which is depicted schematically in FIG. 3. The main lubrication system 162 is configured to provide a lubricant to, for example, various bearings and gear meshes in the compressor section, the turbine section, the HP spool 122, and the LP shaft 124. The lubricant provided by the main lubrication system 162 may increase the useful life of such components and may remove a certain amount of heat from such components through the use of one or more heat exchangers. The compressor cooling air (CCA) system 164 provides air from one or both of the HP compressor 112 or the LP compressor 110 to one or both of the HP turbine 116 or the LP turbine 118. The active thermal clearance control (ATCC) system 166 acts to minimize a clearance between tips of turbine blades and casing walls as casing temperatures vary during a flight mission. The generator lubrication system 168 provides lubrication to an electronic generator (not shown), as well as cooling/heat removal for the electronic generator. The electronic generator may provide electrical power to, for example, a startup electrical motor for the turbofan engine 100 and/or various other electronic components of the turbofan engine 100 and/or an aircraft including the turbofan engine 100. The lubrication systems for the engine 100 (e.g., the main lubrication system 162 and the generator lubrication system 168) may use hydrocarbon fluids, such as oil, for lubrication, in which the oil circulates through inner surfaces of oil scavenge lines.

The turbofan engine 100 discussed herein is provided by way of example only. In other embodiments, any other suitable engine may be utilized with aspects of the present disclosure. For example, in other embodiments, the engine may be any other suitable gas turbine engine, such as a turboshaft engine, a turboprop engine, a turbojet engine, an unducted single fan engine, and the like. In such a manner, in other embodiments, the gas turbine engine may have other suitable configurations, such as other suitable numbers or arrangements of shafts, compressors, turbines, fans, etc. Further, although the turbofan engine 100 is shown as a direct drive, fixed-pitch turbofan engine 100, in other embodiments, a gas turbine engine may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Further, still, in alternative embodiments, aspects of the present disclosure may be incorporated into, or otherwise utilized with any other type of engine, such as reciprocating engines. Additionally, in still other exemplary embodiments, the exemplary turbofan engine 100 may include or be operably connected to any other suitable accessory systems. Additionally, or alternatively, the exemplary turbofan engine 100 may not include or be operably connected to one or more of the accessory systems 162, 164, 166, and 168, discussed above.

FIG. 4 shows a combustor 300 of the combustion section 114 according to an embodiment of the present disclosure. FIG. 4 is a detail view showing detail 3 in FIG. 3. The combustor 300 is an annular combustor that includes a combustion chamber 302 defined between an inner liner 304 and an outer liner 306. Each of the inner liner 304 and outer liner 306 is annular about the longitudinal centerline 101 of the engine 100 (FIG. 3). The combustor 300 also includes a combustor case 308 that is also annular about the longitudinal centerline 101 of the engine 100. The combustor case 308 extends circumferentially around the inner liner 304 and the outer liner 306, and the inner liner 304 and outer liner 306 are located radially inward of the combustor case 308. The combustor 300 also includes a dome 310 mounted to a forward end of each of the inner liner 304 and the outer liner 306. The dome 310 defines an upstream (or forward end) of the combustion chamber 302.

A plurality of mixer assemblies 210 (only one is illustrated in FIG. 4) are spaced around the dome 310. The plurality of mixer assemblies 210 are circumferentially spaced about the longitudinal centerline 101 of the engine 100. In the embodiment shown in FIG. 4, each mixer assembly 210 is a twin annular premixing swirler (TAPS) that includes a main mixer 212 and a pilot mixer (not shown). The pilot mixer is supplied with fuel from the fuel injector 200 during the entire engine operating cycle, and the main mixer 212 is supplied with fuel from the fuel injector 200 only during increased power conditions of the engine operating cycle, such as take-off and climb, for example. The TAPS mixer assembly 210 is provided by way of example and the catalytic metal layer discussed herein may be applied to other mixer assembly designs and other combustor designs.

As noted above, the compressor section, including the HP compressor 112 (FIG. 3), pressurizes air, and the combustor 300 receives an annular stream of this pressurized air from a discharge outlet (compressor discharge outlet 216) of the HP compressor 112. This air may be referred to as compressor discharge pressure air. A portion of the compressor discharge air flows into the mixer assembly 210. Fuel is injected into the air in the mixer assembly 210 to mix with the air and to form a fuel-air mixture. The fuel-air mixture is provided to the combustion chamber 302 from the mixer assembly 210 for combustion. Ignition of the fuel-air mixture is accomplished by a suitable igniter 312, and the resulting combustion gases flow in an axial direction toward and into an annular, first stage turbine nozzle 314. The first stage turbine nozzle 314 is defined by an annular flow channel that includes a plurality of radially extending, circularly-spaced nozzle vanes 316 that turn the gases so that they flow angularly and impinge upon the first stage turbine blades (not shown) of a first turbine (not shown) of the HP turbine 116 (FIG. 3).

The fuel injector 200 is fixed to the combustor case 308 by a nozzle mount. In this embodiment, the nozzle mount is a flange 202 that is integrally formed with a stem 204 of the fuel injector 200. The flange 202 is fixed to the combustor case 308 and sealed to the combustor case 308. The stem 204 includes a flow passage through which the hydrocarbon fuel flows, and the stem 204 extends radially inward from the flange 202. The fuel injector 200 also includes a fuel nozzle tip 220 through which fuel is injected into the combustion chamber 302 as part of the mixer assembly 210.

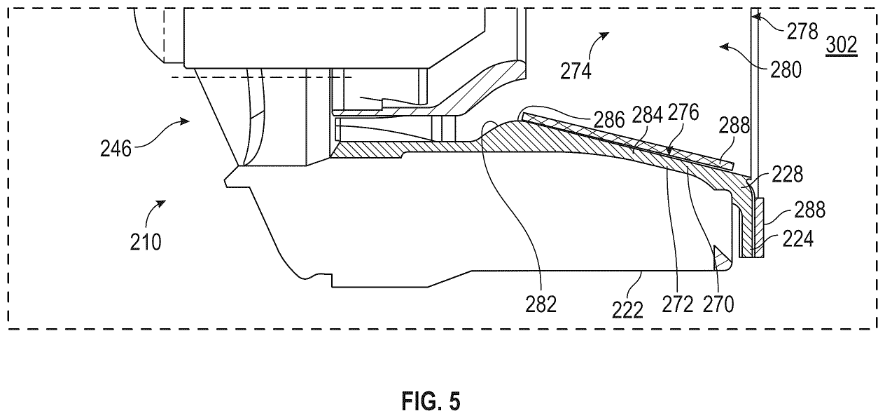

FIG. 5 shows the mixer assembly 210 of the combustor 300 shown in FIG. 4. FIG. 5 is a detail view showing detail 4 in FIG. 4, and, as FIG. 4 is a cross-sectional view, FIG. 5 is also a cross-sectional view of the mixer assembly 210. The fuel nozzle tip 220 includes a fuel nozzle body 222 and an aft heat shield 224 attached to the fuel nozzle body 222. The fuel nozzle body 222 is mounted to an inlet fairing (not shown). The inlet fairing is connected to or integral with the stem 204. The fuel nozzle body 222 includes a main fuel nozzle (not shown) and a dual orifice pilot fuel injector tip (not shown) having a primary pilot fuel orifice (not shown) and a secondary pilot fuel orifice (not shown). The primary pilot fuel orifice and the secondary pilot fuel orifice may be substantially concentric with each other and substantially centered in an annular pilot inlet 246. The main fuel nozzle surrounds the pilot inlet 246, and the pilot inlet 246 is located between the main fuel nozzle and the dual orifice pilot fuel injector tip. In this embodiment, the fuel nozzle tip 220 (see FIG. 4) is circular about an axis extending through the center of the primary pilot fuel orifice. In the discussion below, various features of the fuel nozzle tip 220 may be discussed relative to this axis.

Fuel is provided through the stem 204 to the main fuel nozzle. The main fuel nozzle includes an annular main fuel passage (not shown) disposed in an annular main fuel ring (not shown). The main fuel nozzle includes a circular array of main fuel injection orifices (not shown) or an annular array of main fuel injection orifices extending radially outward from the annular main fuel passage and through the wall of the annular main fuel ring. The main fuel nozzle and the annular main fuel ring are spaced radially outward of the primary pilot fuel orifice and the secondary pilot fuel orifice. The main fuel nozzle injects fuel in a radially outward direction through the circular array of main fuel injection orifices.

Fuel is also provided through the stem 204 to the primary pilot fuel orifice and the secondary pilot fuel orifice. The secondary pilot fuel orifice is radially located directly adjacent to the primary pilot fuel orifice and surrounds the primary pilot fuel orifice. The pilot mixer includes an inner pilot swirler (not shown), an outer pilot swirler (not shown), and a swirler splitter (not shown) positioned between the inner pilot swirler and the outer pilot swirler. The inner pilot swirler is located radially outward of the dual orifice pilot fuel injector tip and adjacent to the dual orifice pilot fuel injector tip. The outer pilot swirler is located radially outward of the inner pilot swirler. The swirler splitter extends downstream of the dual orifice pilot fuel injector tip and a first venturi (not shown) is formed in a downstream portion (not shown) of the swirler splitter. The first venturi includes a converging section (not shown), a diverging section (not shown), and a throat (not shown) between the converging section and the diverging section. The throat is located downstream of the primary pilot fuel orifice and the secondary pilot fuel orifice. The swirler splitter and, more specifically, the downstream portion of the swirler splitter forms a housing for the first venturi. The inner pilot swirler and the outer pilot swirler are generally oriented parallel to a centerline of the dual orifice pilot fuel injector tip. The inner pilot swirler and the outer pilot swirler include a plurality of swirling vanes (not shown) for causing air traveling therethrough to swirl.

A portion of the compressor discharge air flows into the mixer assembly pilot inlet 246 and, then, into the inner pilot swirler and the outer pilot swirler. As noted above, fuel and air are provided to the pilot mixer at all times during the engine operating cycle so that a primary combustion zone is produced within a central portion of the combustion chamber 302. The primary pilot fuel orifice is circular, and the secondary pilot fuel orifice is annular. Each of the primary pilot fuel orifice and the secondary pilot fuel orifice injects fuel in a generally downstream direction and into the compressed air flowing through the inner pilot swirler. The primary pilot fuel orifice and the secondary pilot fuel orifice are examples of a fuel injection port that is fluidly connected to a fuel source and configured to inject a hydrocarbon fuel into the mixer assembly. This fuel and air mixture flows through the first venturi and exits through a circular outlet (not shown). The outlet is downstream of the diverging section.

The pilot mixer is supported by an annular pilot housing 270. The pilot housing 270 includes a conical wall section 272 circumscribing a conical pilot mixing chamber 274 that is in flow communication with, and downstream from, the pilot mixer, and, more specifically, the outlet. The pilot mixing chamber 274 is also fluidly connected to the primary pilot fuel orifice and the secondary pilot fuel orifice, and downstream of the primary pilot fuel orifice and the secondary pilot fuel orifice. The pilot mixing chamber 274 is a passage of the fuel injector 200 and, more specifically, the fuel nozzle tip 220. As the fuel nozzle tip 220 is also a portion of the mixer assembly 210, the pilot mixing chamber 274 also is a passage of the mixer assembly 210.

The conical wall section 272 of the pilot housing 270 is thus a passage wall that includes a passage wall surface 276 facing the pilot mixing chamber 274 (passage). In this embodiment, the conical wall section 272 is part of a second venturi 280 formed by the pilot housing 270. The second venturi 280 includes a converging section 282, a diverging section 284, and a throat 286 between the converging section 282 and the diverging section 284. The diverging section 284 is provided by the conical wall section 272, which extends downstream from the throat 286 and continues with exposed surfaces 228 of the aft heat shield 224. The exposed surfaces 228 of this embodiment form a conical wall section of the aft heat shield 224 that is coplanar with the wall surface 276 of the conical wall section 272. Diverging section 284 has an upstream end, which, in this embodiment, is the throat 286 and a downstream end, which, in this embodiment, is an outlet 278 of the pilot mixing chamber 274. As can be seen in FIG. 5, the cross-sectional area of the second venturi 280 at the outlet 278 (the downstream end) is greater than the cross-sectional area of the second venturi 280 at the throat 286 (the upstream end).

Air flows through the outer pilot swirler through the converging section 282 toward the throat 286. This air is mixed with the fuel-air mixture from the outlet and moves through the throat 286 to the diverging section 284 and the aft heat shield 224. The pilot mixing chamber 274 and, more specifically, the wall surface 276 of the conical wall section 272 are exposed to hydrocarbon fuel as the fuel-air mixture flows through the pilot mixing chamber 274, through the outlet 278 of the pilot mixing chamber 274, and into the combustion chamber 302. Being adjacent to the combustion chamber 302 and adjacent to the primary combustion zone, the fuel, the conical wall section 272, and the aft heat shield 224 are exposed to high temperatures. For example, the conical wall section 272 and the aft heat shield 224 may be at temperatures from three hundred degrees Celsius to six hundred degrees Celsius and from six hundred degrees Celsius to one thousand four hundred degrees Celsius, respectively.

The pilot housing 270 and the aft heat shield 224 are made from materials suitable for use in these high temperature environments including, for example, stainless steel, corrosion-resistant alloys of nickel and chromium, and high-strength nickel-base alloys. The pilot housing 270 and the aft heat shield 224 may thus be formed from a metal alloy chosen from the group consisting of iron-based alloys, nickel-based alloys, cobalt-based alloys, and chromium-based alloys. Exposed surfaces of these materials at these temperatures, and, more particularly, the wall surface 276 may thus be susceptible to a significant build-up of coke and/or partially burned fuel deposits. The coke forming on such materials may be strongly bound to these metallic components of the fuel nozzle tip 220 leading to the formation of a thick layer of coke with large particles. As noted above, coke can build up in considerable thickness on these surfaces and large pieces of coke can shed off, becoming internal domestic objects that can cause significant damage to components downstream of the fuel nozzle (hot gas path components).

To prevent the build-up of coke and the issues discussed above, at least a portion of the surfaces of the second venturi 280, including, for example, the wall surface 276 and the aft heat shield 224 may be coated with the rare earth oxide-based catalyst (referred to herein as a catalyst particle layer 288) to inhibit coke deposition and build-up. As noted above, the pilot mixing chamber 274 is a passage, and, in embodiments discussed herein, a portion of the wall of the passage is a coated passage wall that is coated with the rare earth oxide-based catalyst (the catalyst particle layer 288) including a rare earth oxide. The coated passage wall is located downstream of the fuel injection port (the primary pilot fuel orifice and the secondary pilot fuel orifice, in this embodiment). As noted above, air flows through the pilot mixing chamber 274 (passage) and is introduced by an air inlet. In these embodiments, the air inlet is upstream of the coated passage wall. More specifically, air is introduced into the pilot mixing chamber 274 (passage) by the pilot inlet 246, through the inner pilot swirler and the outer pilot swirler. The air flowing through the inner pilot swirler is also introduced to the pilot mixing chamber 274 via outlet.

Without intending to be bound to any theory, these rare earth oxide-based catalysts promote the formation of fine scale (less than one hundred microns in size) filaments of coke, rather than large grains of coke (greater than two hundred microns in size). These filaments of coke are lightly bound (do not from a strong bond) to the catalyst particle layer 288 and the filamentary coke can be easily removed by normal operation of the fuel nozzle without damage to downstream components.

Exposed surfaces of the underlying (base) material of the pilot housing 270, and, more specifically, the conical wall section 272 or the aft heat shield 224, promote the formation of thick, large grains of coke, and the catalyst particle layer 288 of this embodiment is applied as a continuous layer on the wall surface 276 to avoid discontinuities that would expose the base material. Only a thin layer of the catalyst particle is needed to promote the filamentary coke formation. Depending on the application region, the thickness of the catalyst particle layer 288 can be suitably minimized. The catalyst particle layer 288 may have a thickness of, preferably, less than two hundred microns, and, more preferably, less than one hundred microns. In some embodiments, the thickness of the catalyst particle layer 288 may be from ten microns to two hundred microns. In other embodiments, the catalyst particle layer 288 may have a thickness of, preferably, less than three hundred nanometers, and, more preferably, less than one hundred nanometers. In some embodiments, the thickness of the catalyst particle layer 288 may be from twenty nanometers to three hundred nanometers. In some embodiments, the thickness of the catalyst particle layer 288 may be from three hundred nanometers to ten microns. The catalyst particle may have a size of, preferably, less than or equal to five microns, less than or equal to one hundred nanometers, and, more preferably, less than or equal to fifty nanometers. In some embodiments, the size of the catalyst particle may be less than or equal to twenty-five nanometers. In some embodiments, the size of the catalyst particle may be from one hundred nanometers to ten microns, from 0.5 microns to one micron, or from twenty-five nanometers to two hundred nanometers.

In some embodiments, the catalyst particle layer can have a porosity between forty percent to seventy percent, thus enhancing catalyst efficiency owing to an increased surface area. In some embodiments, the porosity can range between ten percent to thirty percent.

For aerodynamic purposes related to the flow of the fuel-air mixture through the pilot mixing chamber 274, the catalyst particle layer 288 preferably has a very smooth surface finish having a surface roughness Ra from 0.01 microns to 0.4 microns. A smooth surface finish also helps to prevent coke from sticking to the second venturi 280. In some embodiments, the catalyst particle layer 288 may have a surface finish having a surface roughness Ra from five microns to ten microns using air plasma spray and, in other embodiments, from 0.5 microns to 1.5 microns using electron beam physical vapor deposition. Other techniques of catalyst particle layer application may include slurry spray, suspension plasma spray, and solution precursor plasma spray, all of which may have a surface finish having a surface roughness Ra from 0.5 microns to ten microns.

The catalyst particle layer 288 may be applied using any suitable method that produces a continuous or a sporadic catalyst particle layer with the thicknesses, sizes, and surface finishes discussed above. The components discussed herein, such as the diverging section 284 of the second venturi 280 and the exposed surfaces 228 of the aft heat shield 224 can be preferably coated using, for example, liquid spray followed by thermal consolidation (using gel-forming precursor solutions, non-gel-forming precursor solutions, or slurry suspensions), suspension-based or precursor solution-based plasma spray, air plasma spray, electron beam physical vapor deposition, screen-printing, electrodeposition, etching, lithography, or sputtering. For example, a catalyst particle including the cerium oxide-silver-platinum composite can exist as a homogenous composite and can be homogenously coated to the surface of interest by wet chemical methods. Alternatively, the platinum component can be electrodeposited or painted on the surface of interest. After optionally utilizing etching or lithography techniques, the cerium oxide-silver composite can be slurry sprayed or painted onto the surface. Alternatively, the cerium oxide-silver composite can be slurry sprayed or painted on the surface of interest. After optionally utilizing etching or lithography techniques, the platinum component can be sputter deposited or painted on the surface.

On many occasions, coatings applied to aircraft engine components would benefit from repair or re-building to sustain and/or enhance their performance and durability. Such repair or rebuilding can be preferably performed “on-wing,” that is, without engine disassembly or removal of target components. The wet chemical formulations for catalytic coating applications described above (such as the sol-forming and non-sol-forming solutions, suspensions, and slurries) are suited for such on-wing repair or rebuilding using robotic techniques, accessed, for example, through the boroscope ports. The formulation can be directly coated onto the target surfaces and/or repair locations by spraying through nozzles, guided by the boroscope imaging camera.

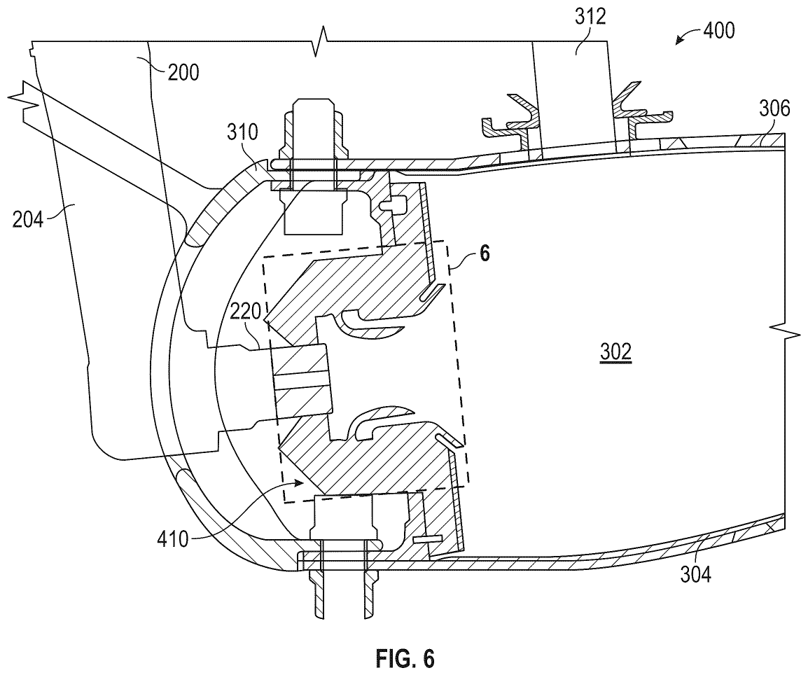

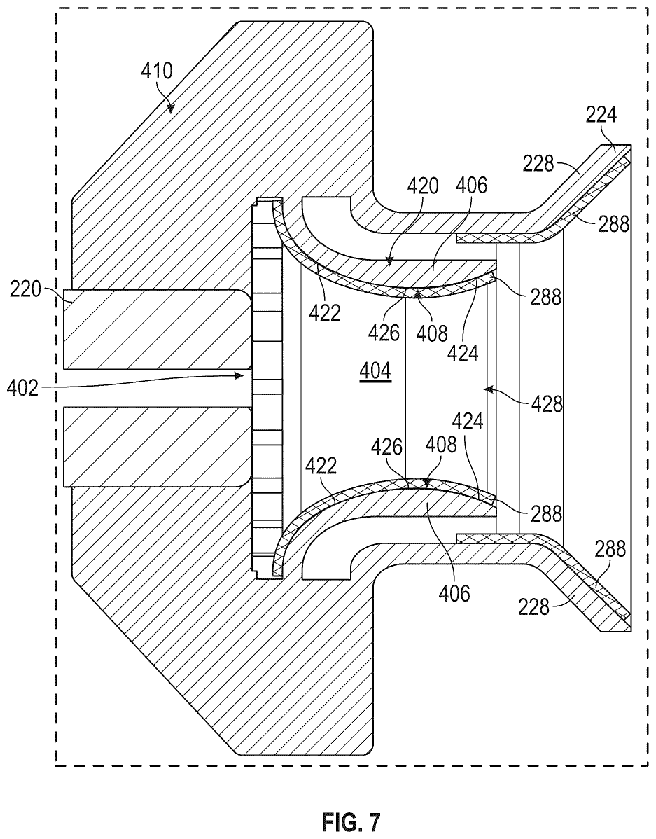

In the preceding discussion, the combustor 300 and the mixer assembly 210 were configured to use a twin annular premixing swirler (TAPS), but the catalyst particle layer 288 discussed herein may be applied to other mixer assembly designs and other combustor designs. Another example of a combustor 400 is shown in FIG. 6. FIG. 6 is a cross-sectional view of the combustor 400 showing a rich burn combustor design. FIG. 7 shows a mixer assembly 410 of the combustor 400 shown in FIG. 6. FIG. 7 is a detail view showing detail 6 in FIG. 6, and, as FIG. 6 is a cross-sectional view, FIG. 7 is also a cross-sectional view of the mixer assembly 410. The combustor 400 and the mixer assembly 410 of this embodiment include the same or similar components as the combustor 300 and the mixer assembly 210 discussed above. Components in this embodiment that are the same or similar to those discussed above are identified with the same reference numeral and a detailed description of these components is omitted.

The combustor 400 of this embodiment shows a rich burn combustor. A plurality of mixer assemblies 410 (only one is illustrated) are spaced around the dome 310. Fuel is injected into the mixer assembly 410 by a fuel injection port 402. The fuel injection port 402 injects fuel in a generally downstream direction and into the compressed air flowing through a first swirler (not shown). The fuel is injected into a mixing chamber 404 that mixes the fuel with the compressed air to form a fuel-air mixture. As with the pilot mixing chamber 274 discussed above, the mixing chamber 404 of this embodiment is a passage of the fuel injector 200 with a wall section 406 that includes a passage wall surface 408 facing the mixing chamber 404 (passage). In this embodiment, wall section 406 is part of a venturi 420 that includes a converging section 422, a diverging section 424, and a throat 426 between the converging section 422 and the diverging section 424. In this embodiment, the catalyst particle layer 288 is formed on the surfaces of the venturi 420. The fuel-air mixture exits through an outlet 428 of the mixing chamber 404 and is combined with air flowing through a second swirler (not shown) at a position upstream of the exposed surfaces 228 of the aft heat shield 224. In this embodiment, catalyst particle layer 288 is also formed on the exposed surface 228 of the aft heat shield 224.

### EXAMPLES

Specific embodiments will be demonstrated by reference to the following examples. These examples are disclosed solely by way of illustrating the present disclosure and should not be taken in any way to limit the scope of the present disclosure.

### Example 1: Synthesis and Coating of Cerium Oxide-Silver Composite

The inventors synthesized a cerium oxide-silver composite (CeO₂-10 wt % Ag) via coprecipitation using aqueous solutions of nitrate salts of cerium (Ce(NO₃)₃·6H₂O) and silver (AgNO₃) as starting materials. The inventors added an ammonia solution dropwise with magnetic stirring to a mixture of the two solutions to obtain hydroxide precipitates of cerium and silver. The inventors continued stirring at room temperature overnight to allow homogenization of the precipitates, having a brown final color. The inventors heated the precipitate mixture at forty to eighty degrees Celsius for one hour with stirring then cooled the precipitate mixture to room temperature. The inventors diluted the precipitates with water and separated the precipitates from the aqueous medium via centrifugation or filtration. The inventors thoroughly washed the precipitates with water then with ethanol or acetone and dried the precipitates in an oven at one hundred degrees Celsius. The inventors heat-treated the product in a furnace at five hundred degrees Celsius for one to six hours to obtain a powder form of the cerium oxide-silver catalyst. The silver component was ten weight percent of the final cerium oxide-silver composite powder.

The inventors mixed the cerium oxide-silver composite powder with a suitable binder in ethanol to form a sprayable slurry. The inventors spray-coated the cerium oxide-silver composite slurry onto substrates of metal, ceramic, and INCONEL® 625. Depending on the substate type, the inventors coated a primer layer prior to the spraying of the cerium oxide-silver catalyst slurry to ensure adherence and thermal cycling durability of the coating. The inventors heat-treated the spray-coated substrates at five hundred degrees Celsius for one hour. The resulting thickness of the cerium oxide-silver composite ranged from ten microns to two hundred microns by varying the number of spray passes.

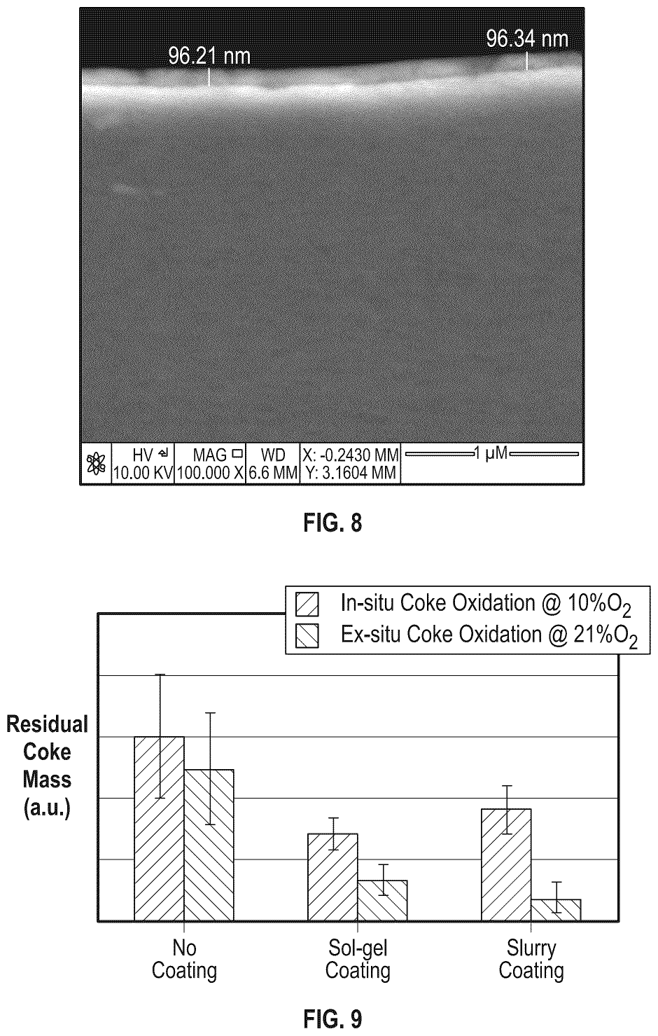

Alternatively, the inventors synthesized the cerium oxide-silver composite by dispersing silver paste via sonication in a cerium-based solution (CeCl₃·7H₂O and citric acid dissolved ethanol). The inventors used this dispersion to coat the substrates with the cerium oxide-silver composite via dip-coating, wash-painting, or brush-painting. The inventors heat-treated the coated substrates at five hundred degrees Celsius for one hour. The resulting thickness of the cerium oxide-silver catalyst ranged from twenty nanometers to three hundred nanometers. FIG. 8 shows an SEM image of a cross section of a thin sol-gel derived CeO₂ coating on an INCONEL® 625 substrate. The thickness of the CeO₂ coating ranged from 96.21 nanometers to 96.34 nanometers.

FIG. 9 shows the efficacy of coke combustion at various oxygen levels using the two types of cerium oxide-silver composites. Substrates having the cerium-oxide-silver catalyst coating using either the slurry coating method or the sol-gel coating method exhibited less residual coke mass than a substrate with no coating.

### Example 2: Differential Scanning Calorimetry and Thermogravimetry of Coke Oxidation in the Presence and Absence of Cerium Oxide-Silver Composite Catalyst

The inventors conducted differential scanning calorimetry (DSC) and thermogravimetry (TG) studies to determine the efficiency of the cerium oxide-silver composite catalyst to oxidize carbon or coke. The inventors mixed each of the cerium oxide-silver composite powder obtained from Example 1, a CeO₂ powder having a size from 0.5 microns to 5 microns (referred to as “micron CeO₂”), and a CeO₂ powder having a size of less than 25 nanometers (referred to as “nano CeO₂”) with a 325-mesh carbon black powder at a 4:1 weight ratio. The inventors grounded the powder mixture using a mortar and pestle then pressed the powder mixture into a pellet to form a tight catalyst-carbon contact. The inventors also made a control sample by forming a pellet using 325-mesh carbon black only. The pellets had a diameter of 5.5 millimeters and a thickness of 1.5 millimeters. The inventors loaded the pellets onto an alumina crucible and placed on a DSC-TG instrument stage against a blank alumina reference crucible. The inventors subjected the samples to a heating ramp from room temperature to eight hundred degrees Celsius at a rate of ten degrees Celsius per minute. For the DSC study, the inventors measured the differences in the magnitude of heat required to increase the temperature of the samples with respect to the reference as a function of temperature (heat flow versus temperature in Celsius). For the TG study, the inventors simultaneously recorded the weight profiles of the samples using the instrument (in %). The inventors normalized the TG plots to reflect the carbon loss percentages in the samples. Based on the difference in heat flow between the sample and the reference, the instrument calculated the magnitude of heat absorbed or released (endothermic or exothermic processes, respectively) during thermal events in the sample. The DSC plots captured the carbon oxidation reaction (C+O₂→CO₂) as an exothermic peak.

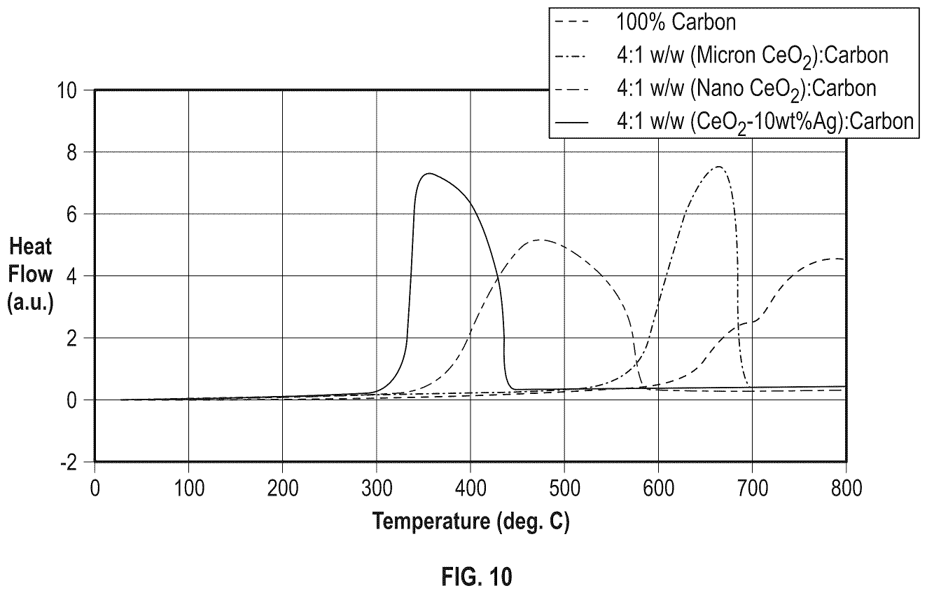

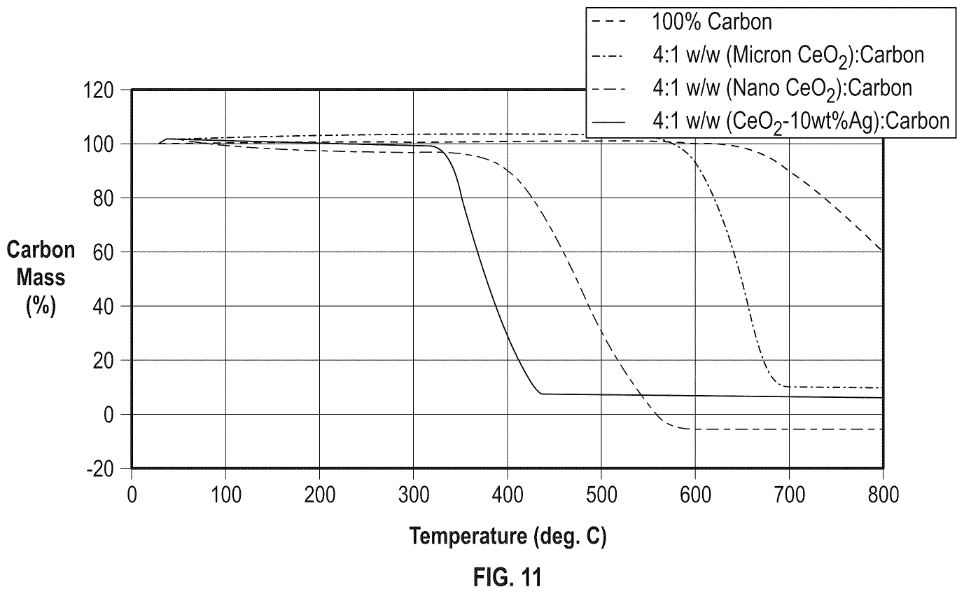

FIG. 10 represents the DSC study showing the heat released resulting from the coke oxidation reaction for three cerium oxide-based sample pellets and the control pellet as a function of temperature. FIG. 11 represents the TG study showing the consumption of carbon mass of the three cerium oxide-based sample pellets and the control pellet as a function of temperature. The mass loss onset temperature shown in FIG. 11 is consistent with the DSC studies shown in FIG. 10. The inventors observed a lowering of carbon burn-off onset temperatures (that is, the lowering of an onset of the exotherm) with the aid of the cerium oxide-based catalysts. Notably, the CeO₂-10 wt % Ag sample underwent carbon oxidation between three hundred degrees Celsius and four hundred fifty degrees Celsius. Using CeO₂-10 wt % Ag exhibited a reduction of more than three hundred degrees Celsius of the onset temperature for coke oxidation compared to the control sample. The nano CeO₂ sample underwent carbon oxidation between three hundred fifty degrees Celsius and six hundred degrees Celsius. A steeper slope of the exotherm at the onset was observed for all three cerium oxide-based samples compared to the control sample, indicating faster kinetics of the oxidation reaction.

As demonstrated by the examples, a rare earth oxide-based catalyst coating, with or without a noble metal component, can effectively reduce coke buildup during engine operation at operating temperatures of the engine.

Further aspects of the present disclosure are provided by the subject matter of the following clauses.

A mixer assembly for a gas turbine engine includes a housing including a passage formed therein and a passage wall facing the passage and a fuel injection port fluidly connected to a fuel source and configured to inject a hydrocarbon fuel into the passage. At least a portion of the passage wall being a coated passage wall, the coated passage wall being (i) coated with a layer of a plurality of catalyst particles including a rare earth oxide component and (ii) located downstream of the fuel injection port.

The mixer assembly of the preceding clause, each of the catalyst particles having a size of less than or equal to five microns, optionally ranging from 0.5 microns to one micron, or optionally ranging from twenty-five nanometers to two hundred nanometers.

The mixer assembly of any preceding clause, the rare earth oxide component including at least one of CeO₂, Y₂O₃, Pr₂O₃, La₂O₃, Nd₂O₃, Sm₂O₃, Gd₂O₃, and Tb₄O₇.

The mixer assembly of any preceding clause, the catalyst particle including at least one of manganese oxide, zirconium oxide, titanium oxide, copper oxide, bismuth oxide, and tin oxide.

The mixer assembly of any preceding clause, an operating temperature ranging from one hundred fifty degrees Celsius to six hundred degrees Celsius or an operating temperature ranging from six hundred degrees Celsius to one thousand four hundred degrees Celsius.

The mixer assembly of any preceding clause, the passage being a venturi including a diverging section, the passage wall including the diverging section, the coated passage wall including the diverging section.

The mixer assembly of any preceding clause, the rare earth oxide component being a cerium-based oxide.

The mixer assembly of any preceding clause, the rare earth oxide component including at least one of zirconium, hafnium, praseodymium, neodymium, promethium, samarium, europium, gadolinium, terbium, dysprosium, holmium, erbium, thulium, ytterbium, and lutetium.

The mixer assembly of any preceding clause, the rare earth oxide component including at least one of an alkali metal and an alkaline earth metal.

The mixer assembly of any preceding clause, the catalyst particle including a noble metal component.

The mixer assembly of any preceding clause, the noble metal component including at least one of a silver component and a platinum component.

The mixer assembly of any preceding clause, the rare earth oxide component being a cerium-based oxide, the noble metal component including a silver component, and a content of the silver component ranging from five weight percent to twenty weight percent of the catalyst particle.

The mixer assembly of any preceding clause, the rare earth oxide component being a cerium-based oxide, the noble metal component including a platinum component, and a content of the platinum component ranging from forty weight percent to eighty weight percent of a total noble metal component.

The mixer assembly of any preceding clause, the passage including an aft heat shield, the coated passage wall including a surface of the aft heat shield.

The mixer assembly of any preceding clause, the aft heat shield including a thermal barrier coating, the layer of the plurality of the catalyst particle being coated onto a surface of the thermal barrier coating.

The mixer assembly of any preceding clause, including a pilot fuel injector tip including a least one pilot fuel orifice, the fuel injection port being the pilot fuel orifice, and a pilot swirler is located radially outward of the pilot fuel injector tip and adjacent to the pilot fuel injector tip, air being configured to flow through the pilot swirler and to mix with fuel from the pilot fuel orifice as a fuel-air mixture, the pilot swirler having an outlet configured to discharge the fuel-air mixture into the passage.

The mixer assembly of any preceding clause, including an array of main fuel injection orifices configured to inject fuel in a radially outward direction, the main fuel injection orifices being located radially outward from the passage.

The mixer assembly of any preceding clause, the passage being a venturi including a converging section, a diverging section, and a throat, the coated passage wall including a passage wall of the diverging section, and the outlet of the pilot swirler being located upstream of the diverging section.

A gas turbine engine includes a combustor including a combustion chamber, and the mixer assembly of any preceding clause configured to inject a mixture of air and hydrocarbon fuel into the combustion chamber. A method of repairing or re-building a mixer assembly of any preceding clause, comprising coating at least a portion of the passage wall with a layer of a plurality of catalyst particles comprising a rare earth oxide component to form a coated passage wall, the coated passage wall located downstream of a fuel injection port. Although the foregoing description is directed to some exemplary embodiments of the present disclosure, other variations and modifications will be apparent to those skilled in the art, and may be made without departing from the spirit or the scope of the disclosure. Moreover, features described in connection with one embodiment of the present disclosure may be used in conjunction with other embodiments, even if not explicitly stated above.

1. A mixer assembly for a gas turbine engine, the mixer assembly comprising:
a housing including a passage formed therein and a passage wall facing the passage; and
a fuel injection port fluidly connected to a fuel source and configured to inject a hydrocarbon fuel into the passage,
wherein at least a portion of the passage wall is a coated passage wall, the coated passage wall being (i) coated with a layer of a plurality of catalyst particles comprising a rare earth oxide component and (ii) located downstream of the fuel injection port.

2. The mixer assembly of claim 1, wherein each of the catalyst particles has a size of less than or equal to five microns.

3. The mixer assembly of claim 1, wherein the rare earth oxide component comprises at least one of CeO₂, Y₂O₃, Pr₂O₃, La₂O₃, Nd₂O₃, Sm₂O₃, Gd₂O₃, and Tb₄O₇.

4. The mixer assembly of claim 1, wherein the catalyst particle further comprises at least one of manganese oxide, zirconium oxide, titanium oxide, copper oxide, bismuth oxide, and tin oxide.

5. The mixer assembly of claim 1, wherein an operating temperature ranges from one hundred fifty degrees Celsius to six hundred degrees Celsius.

6. The mixer assembly of claim 1, wherein an operating temperature ranges from six hundred degrees Celsius to one thousand four hundred degrees Celsius.

7. The mixer assembly of claim 1, wherein the passage is a venturi including a diverging section, wherein the passage wall includes the diverging section, wherein the coated passage wall includes the diverging section.

8. The mixer assembly of claim 1, wherein the rare earth oxide component is a cerium-based oxide.

9. The mixer assembly of claim 8, wherein the rare earth oxide component further comprises at least one of zirconium, hafnium, praseodymium, neodymium, promethium, samarium, europium, gadolinium, terbium, dysprosium, holmium, erbium, thulium, ytterbium, and lutetium.

10. The mixer assembly of claim 8, wherein the rare earth oxide component further comprises at least one of an alkali metal and an alkaline earth metal.

11. The mixer assembly of claim 1, wherein the catalyst particle further comprises a noble metal component.

12. The mixer assembly of claim 11, wherein the noble metal component comprises at least one of a silver component and a platinum component.

13. The mixer assembly of claim 11, wherein the rare earth oxide component is a cerium-based oxide, wherein the noble metal component comprises a silver component, and wherein a content of the silver component ranges from five weight percent to twenty weight percent of the catalyst particle.

14. The mixer assembly of claim 11, wherein the rare earth oxide component is a cerium-based oxide, wherein the noble metal component comprises a platinum component, and wherein a content of the platinum component ranges from forty weight percent to eighty weight percent of a total noble metal component.

15. The mixer assembly of claim 1, wherein the passage includes an aft heat shield, the coated passage wall including a surface of the aft heat shield.

16. The mixer assembly of claim 15, wherein the aft heat shield includes a thermal barrier coating, wherein the layer of the plurality of the catalyst particle is coated onto a surface of the thermal barrier coating.

17. The mixer assembly of claim 1, further comprising:
a pilot fuel injector tip including a least one pilot fuel orifice, the fuel injection port being the pilot fuel orifice; and
a pilot swirler is located radially outward of the pilot fuel injector tip and adjacent to the pilot fuel injector tip, air being configured to flow through the pilot swirler and to mix with fuel from the pilot fuel orifice as a fuel-air mixture, the pilot swirler having an outlet configured to discharge the fuel-air mixture into the passage.

18. The mixer assembly of claim 17, further comprising an array of main fuel injection orifices configured to inject fuel in a radially outward direction, the main fuel injection orifices being located radially outward from the passage.

19. The mixer assembly of claim 17, wherein the passage is a venturi including a converging section, a diverging section, and a throat, the coated passage wall including a passage wall of the diverging section, and the outlet of the pilot swirler being located upstream of the diverging section.

20. A gas turbine engine comprising:
a combustor including a combustion chamber; and
the mixer assembly of claim 1 configured to inject a mixture of air and hydrocarbon fuel into the combustion chamber.
